(19) United States
(12) Patent Application Publication
(10) Pub. No.: US 2022/0271285 A1
(43) Pub. Date: Aug. 25, 2022

(54) Cathode Active Material for Lithium Secondary Battery and Lithium Secondary Battery Including the Same

(71) Applicant: SK ON CO., LTD., Seoul (KR)

(72) Inventors: Young Hoon Do, Daejeon (JP); Sang Wook Lee, Daejeon (JP); Yong Hyun Cho, Daejeon (JP)

(21) Appl. No.: 17/673,047

(22) Filed: Feb. 16, 2022

(30) Foreign Application Priority Data
Feb. 17, 2021 (KR) 10-2021-0021229

(51) Int. Cl. H01M 4/525; H01M 10/0525

(52) U.S. Cl. CPC H01M 4/525; H01M 2004/028; H01M 10/0525

(57) ABSTRACT

A cathode active material for a lithium secondary battery according to exemplary embodiments includes a lithium metal oxide containing 80 mol % or more of nickel of all elements except for lithium and oxygen, and has a particle size distribution change rate and a specific surface area change rate value satisfying a predetermined range.

### CROSS-REFERENCE TO RELATED APPLICATION

This application claims priority to Korean Patent Application No. 10-2021-0021229 filed Feb. 17, 2021, the disclosure of which is hereby incorporated by reference in its entirety.

### BACKGROUND OF THE INVENTION

### 1. Field of the Invention

The present invention relates to a cathode active material for a lithium secondary battery and a lithium secondary battery including the same, and more particularly, to a cathode active material including a high nickel-based lithium metal oxide and a lithium secondary battery including the same.

### 2. Description of the Related Art

A secondary battery is a battery which can be repeatedly charged and discharged, and has been widely applied to portable electronic devices such as a mobile phone, a laptop computer, etc. as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, and is advantageous in terms of a charging speed and light weight. In this regard, the lithium secondary battery has been actively developed and applied as a power source.

A cathode of the lithium secondary battery includes a cathode active material capable of reversibly intercalating and deintercalating lithium ions. For example, the cathode active material may include lithium composite oxides.

The lithium composite oxide may include, for example, metal elements such as nickel, cobalt, manganese, aluminum and the like.

As a field, to which the lithium secondary battery is applied, is expanded to large devices such as a hybrid vehicle, etc., research and development for a high nickel-based lithium composite oxide having an increased nickel content to secure a high capacity thereof have been actively conducted.

For example, Korean Patent Registration Publication No. 10-0821523 discloses a method of manufacturing a cathode active material including a high nickel-based lithium composite oxide.

### SUMMARY OF THE INVENTION

An object of the present invention is to provide a cathode active material for a lithium secondary battery having excellent mechanical stability and chemical stability.

In addition, another object of the present invention is to provide a lithium secondary battery having a high capacity and excellent life-span characteristics.

To achieve the above objects, according to an aspect of the present invention, there is provided a cathode active material for a lithium secondary battery including: a lithium metal oxide containing 80 mol % or more of nickel among all elements except for lithium and oxygen, wherein the cathode active material has a particle size distribution change rate (ΔX) of 60% or less represented by Equation 1 below, and a specific surface area change rate (ΔY) of 50% or less represented by Equation 2 below:

ΔX(%)=(X_{4.5t}−X)/X×100 [Equation 1]

ΔY(%)=(Y_{4.5t}−Y)/Y×100 [Equation 2]

(in Equation 1, X is a (D₉₀−D₁₀)/D₅₀ value of the cathode active material measured without pressure-treating the cathode active material, and X_{4.5t} is a (D₉₀−D₁₀)/D₅₀ value of the cathode active material measured after pressure-treating the cathode active material at 4.5 t/cm² for 1 minute, and

in Equation 2, Y is a BET value of the cathode active material measured without pressure-treating the cathode active material, and Y_{4.5t} is a BET value of the cathode active material measured after pressure-treating the cathode active material at 4.5 t/cm² for 1 minute).

In one embodiment, X may be 1 to 2.

In one embodiment, X_{4.5t} may be greater than 1 and 3 or less.

In one embodiment, the particle size distribution change rate (ΔX) may be 40% or less, and the specific surface area change rate (ΔY) may be 30% or less:

In one embodiment, the particle size D₁₀, D₅₀ and D₉₀ of the cathode active material measured without the pressure-treating the cathode active material, respectively, 3 to 6 μm, 8 to 15 μm and 15 to 22 μm.

In one embodiment, the particle size D₁₀, D₅₀ and D₉₀ of the cathode active material measured after the pressure-treating the cathode active material at 4.5 t/cm² for 1 minute, respectively, 2 to 4 μm, 5 to 14 μm and 14 to 20 μm.

In one embodiment, a change rate (ΔD₅₀) of the particle size D₅₀ of the cathode active material before and after the pressurization treatment at 4.5 t/cm² for 1 minute represented by Equation 3 below is 50% or less:

ΔD₅₀(%)=(D₅₀ measured without the pressurization treatment−D₅₀ measured after the pressurization treatment)/D₅₀ measured without the pressurization treatment×100. [Equation 3]

In one embodiment, the lithium metal oxide may be represented by Formula 1 below:

LiₓNiₐCo_{b}M_{c}O_{y} [Formula 1]

(in Formula 1, M is at least one of Al, Zr, Ti, B, Mg, Mn, Ba, Si, Y, W and Sr, and x, y, a, b and c are in a range of 0.9≤x≤1.2, 1.9≤y≤2.1, 0.8≤a≤1, 0≤c/(a+b)≤0.13 and 0≤c≤0.11, respectively).

According to another aspect of the present invention, there is provided a lithium secondary battery including: a cathode which includes the cathode active material; and an anode disposed to face the cathode.

The cathode active material for a lithium secondary battery according to exemplary embodiments has a high nickel content, such that a lithium secondary battery having a high capacity may be implemented.

The cathode active material for a lithium secondary battery according to exemplary embodiments has a particle size distribution change rate and a specific surface area change rate before and after pressurization satisfying a predetermined range, respectively, such that a lithium secondary battery having improved high temperature life-span characteristics and high temperature storage performance may be implemented.

### BRIEF DESCRIPTION OF THE DRAWING

The above and other objects, features and other advantages of the present invention will be more clearly understood from the following detailed description taken in conjunction with the accompanying drawing, in which:

FIG. 1 is a schematic cross-sectional view illustrating a lithium secondary battery according to an embodiment of the present invention.

### DESCRIPTION OF THE INVENTION

As used herein, the term “lithium metal oxide” refers to an oxide capable of intercalating and deintercalating lithium ions, and may include lithium and metal elements.

Hereinafter, the present invention will be described in more detail.

According to the present invention, there is provided a cathode active material for a lithium secondary battery, which includes a lithium metal oxide containing nickel in a predetermined content or more, and has a particle size distribution change rate and a specific surface area change rate satisfying a predetermined range, respectively, which are represented by Equations 1 and 2 to be described below. In addition, there is provided a lithium secondary battery including the cathode active material for a lithium secondary battery.

### Cathode Active Material for Lithium Secondary Battery

The cathode active material for a lithium secondary battery according to exemplary embodiments may include a lithium metal oxide containing nickel (Ni) of 80 mol % or more of all elements except for lithium and oxygen.

In some embodiments, the lithium metal oxide may contain 85 mol % or more, 90 mol % or more, or 95 mol % or more of nickel of all elements except for lithium and oxygen. Within the above range, it is possible to implement a lithium secondary battery having an improved capacity.

In one embodiment, the lithium metal oxide may be represented by Formula 1 below.

LiₓNiₐCo_{b}M_{c}O_{y} [Formula 1]

In Formula 1, M may be at least one of Al, Zr, Ti, B, Mg, Mn, Ba, Si, Y, W and Sr, and x, y, a, b and c may be in a range of 0.9≤x≤1.2, 1.9≤y≤2.1, 0.8≤a≤1, 0≤c/(a+b)≤0.13 and 0≤c≤0.11, respectively.

In some embodiments, a may be in a range of 0.85≤a<1, 0.9≤a<1, or 0.95≤a<1.

In one embodiment, the lithium metal oxide may include a coating element or a doping element. For example, the coating element or the doping element may include Al, Ti, Ba, Zr, Si, B, Mg, P, Sr, W, La or the like. In this case, it is possible to implement a secondary battery having more improved life-span characteristics.

In one embodiment, the lithium metal oxide may have a form of secondary particles in which primary particles are aggregated. Alternatively, the lithium metal oxide may also have a form of a single particle (monolith). The primary particle and the single particle may refer to a particle which exists alone without forming an aggregate.

The cathode active material for a lithium secondary battery according to exemplary embodiments may have a particle size distribution change rate (ΔX) of 60% or less represented by Equation 1 below.

In addition, the cathode active material for a lithium secondary battery according to exemplary embodiments may have a specific surface area change rate (ΔY) of 50% or less represented by Equation 2 below.

ΔX(%)=(X_{4.5t}−X)/X×100 [Equation 1]

ΔY(%)=(Y_{4.5t}−Y)/Y×100 [Equation 2]

In Equation 1, X is a (D₉₀−D₁₀)/D₅₀ value of the cathode active material measured without pressure-treating the cathode active material, and X_{4.5t} is a (D₉₀−D₁₀)/D₅₀ value of the cathode active material measured after pressure-treating the cathode active material at 4.5 t/cm² for 1 minute.

In Equation 2, Y is a BET value of the cathode active material measured without pressure-treating the cathode active material, and Y_{4.5t} is a BET value of the cathode active material measured after pressure-treating the cathode active material at 4.5 t/cm² for 1 minute.

For example, when a content of nickel in the lithium metal oxide is high, a secondary battery having a high capacity may be implemented. However, in the case of lithium metal oxide containing nickel in a high content, breakage of the particles is very serious during rolling for manufacturing a cathode. In this case, side reactions between the lithium metal oxide and the electrolyte may be increased. In addition, high temperature life-span characteristics (e.g., high temperature capacity retention rate) and high temperature storage performance (e.g., gas generation during charging and discharging) of the secondary battery may be deteriorated.

However, when the cathode active material has a particle size distribution change rate and a specific surface area change rate satisfying the above-described ranges, a secondary battery having excellent high temperature life-span characteristics and high temperature storage performance may be implemented even if including nickel in a high content.

For example, the particle size distribution change rate and the specific surface area change rate may be calculated by pressure-treating the cathode active material at 4.5 t/cm² for 1 minute and measuring change rate values before and after the pressurization. The pressure magnitude is similar to the rolling pressure magnitude during manufacturing the cathode, such that the particle size distribution change rate and the specific surface area change rate may be a clearer measure.

When describing Equation 1 above in more detail, the particle size distribution change rate (ΔX) is calculated by (X_{4.5t}−X)/X×100, wherein X may mean the (D₉₀−D₁₀)/D₅₀ value measured without pressure-treating the cathode active material. In addition, X_{4.5t} may mean a (D₉₀−D₁₀)/D₅₀ value measured after pressure-treating the cathode active material at 4.5 t/cm² for 1 minute.

For example, the particle size distribution change rate (ΔX) means an absolute value, and may exceed 0.

For example, the particle size of the cathode active material may be measured by a laser diffraction method using a laser diffraction particle size measuring device (e.g., Microtrac, MT 3000).

For example, based on a volume particle size distribution derived by the laser diffraction method, D₁₀ may mean a particle size at a point of 10% of the volume particle size distribution. In addition, D₅₀ may mean a particle size at a point of 50% of the volume particle size distribution, and D₉₀ may mean a particle size at a point of 90% of the volume particle size distribution.

When describing Equation 2 above in more detail, the specific surface area change rate (ΔY) is calculated by (Y_{4.5t}−Y)/Y×100, wherein Y may mean the BET value measured without pressure-treating the cathode active material. In addition, Y_{4.5t} may mean a BET value measured after pressure-treating the cathode active material at 4.5 t/cm² for 1 minute.

For example, the BET value may be calculated according to a gas adsorption/desorption method using a BET measuring instrument (Micrometrics, ASAP2420).

For example, the specific surface area change rate (ΔY) means an absolute value, and may exceed 0.

In some embodiments, the particle size distribution change rate (ΔX) may be 50% or less, and preferably 40% or less. Within the above range, it is possible to implement a secondary battery having more improved high temperature life-span characteristics and high temperature storage performance.

In some embodiments, the specific surface area change rate ΔY may be 40% or less, and preferably 30% or less. Within the above range, it is possible to implement a secondary battery having more improved high temperature life-span characteristics and high temperature storage performance.

In some embodiments, X may be 1 to 2, and preferably 1.1 to 1.4. In addition, the X_{4.5t} may be greater than 1 and 3 or less, and preferably 1.3 to 1.8. For example, X_{4.5t} may be a value greater than X. Within the above range, it is possible to implement a secondary battery having more improved high temperature life-span characteristics and high temperature storage performance.

In one embodiment, the particle size D₁₀, D₅₀ and D₉₀ of the cathode active material measured without the pressure-treating the cathode active material, respectively, 3 to 6 μm, 8 to 15 μm and 15 to 22 μm.

In one embodiment, the particle size D₁₀, D₅₀ and D₉₀ of the cathode active material measured after the pressure-treating the cathode active material at 4.5 t/cm² for 1 minute, respectively, 2 to 4 μm, 5 to 14 μm and 14 to 20 μm.

In some embodiments, a change rate (ΔD₅₀) of the particle size D₅₀ of the cathode active material before and after the pressurization treatment at 4.5 t/cm² for 1 minute may be 50% or less, and preferably 30% or less. Within the above range, it is possible to implement a secondary battery having better high temperature life-span characteristics and high temperature storage performance. The change rate (ΔD₅₀) may be calculated by Equation 3.

ΔD₅₀(%)=(D₅₀ measured without the pressurization treatment−D₅₀ measured after the pressurization treatment)/D₅₀ measured without the pressurization treatment×100. [Equation 3]

Lithium Secondary Battery

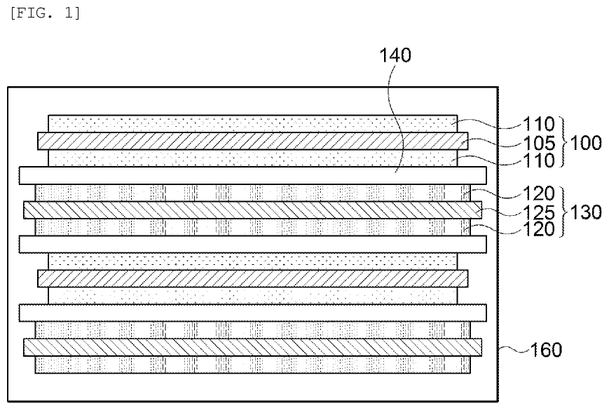

FIG. 1 is a cross-sectional view schematically illustrating a lithium secondary battery according to exemplary embodiments.

Referring to FIG. 1, the lithium secondary battery may include a cathode 100 and an anode 130 disposed to face the cathode 100.

In one embodiment, the lithium secondary battery may include a separation membrane 140 interposed between the cathode 100 and the anode 130.

The cathode 100 may include a cathode current collector 105 and a cathode active material layer 110 on the cathode current collector 105.

The cathode active material layer 110 may include a cathode active material, and if necessary, a cathode binder and a conductive material.

The cathode 100 may be prepared, for example, by mixing and stirring the cathode active material, the cathode binder, and the conductive material, etc. in the dispersion medium to prepare a cathode slurry, and then coating the cathode current collector 105 with the cathode slurry, followed by drying and rolling the same.

The cathode current collector 105 may include, for example, stainless steel, nickel, aluminum, titanium, copper, or an alloy thereof, and preferably, includes aluminum or an aluminum alloy.

The cathode active material may include the above-described cathode active material of the present invention.

The cathode binder may include, for example, an organic binder such as polyvinylidene fluoride (PVDF), vinylidene fluoride-hexafluoropropylene copolymer (PVDF-co-HFP), polyacrylonitrile, polymethyl methacrylate, etc., or an aqueous binder such as styrene-butadiene rubber (SBR). In addition, the cathode binder may be used together with a thickener such as carboxymethyl cellulose (CMC).

The conductive material may include, for example, a carbon-based conductive material such as graphite, carbon black, graphene, or carbon nanotubes and/or a metal-based conductive material such as tin, tin oxide, titanium oxide, or a perovskite material such as LaSrCoO₃, and LaSrMnO₃.

The anode 130 may include an anode current collector 125 and an anode active material layer 120 on the anode current collector 125.

The anode active material layer 120 may include an anode active material, and if necessary, an anode binder and a conductive material.

The anode 130 may be prepared, for example, by mixing and stirring the anode active material, the anode binder and the conductive material, etc. in a solvent to prepare an anode slurry, and then coating the anode current collector 125 with the anode slurry, followed by drying and rolling the same.

The anode current collector 125 may include, for example, gold, stainless steel, nickel, aluminum, titanium, copper or an alloy thereof, and preferably, includes copper or a copper alloy.

The anode active material may be a material capable of intercalating and deintercalating lithium ions. The anode active material may include, for example, a carbon-based material such as crystalline carbon, amorphous carbon, carbon composite material, or carbon fiber, etc.; a silicone-based material; a lithium alloy and the like.

The amorphous carbon may be, for example, hard carbon, cokes, mesocarbon microbead (MCMB) calcined at 1500° C. or lower, mesophase pitch-based carbon fiber (MPCF) or the like. The crystalline carbon may be, for example, natural graphite, artificial graphite, graphite cokes, graphite MCMB, graphite MPCF or the like.

The silicon material may include, for example, Si, SiOₓ (0<x<2), Si/C, SiO/C, Si-metal or the like.

The lithium alloy may include, for example, a metal element such as aluminum, zinc, bismuth, cadmium, antimony, silicon, lead, tin, gallium, indium or the like.

The anode binder and the conductive material may be substantially the same as or similar to the above-described cathode binder and the conductive material. The anode binder may be, for example, an aqueous binder such as styrene-butadiene rubber (SBR) for consistency with the carbon-based active material, and may be used together with a thickener such as carboxymethyl cellulose (CMC).

The separation membrane 140 may be interposed between the cathode 100 and the anode 130. In some embodiments, the anode 130 may have an area (e.g., a contact area with the separation membrane 140) larger than that of the cathode 100. Thereby, lithium ions generated from the cathode 100 may smoothly move to the anode 130 without being precipitated in the middle.

The separation membrane 140 may include a porous polymer film made of a polyolefin polymer such as ethylene homopolymer, propylene homopolymer, ethylene/butene copolymer, ethylene/hexene copolymer, ethylene/methacrylate copolymer.

The separation membrane 140 may include a nonwoven fabric made of glass fiber having a high melting point, polyethylene terephthalate fiber or the like.

An electrode cell may be formed by including the cathode 100, the anode 130 and the separation membrane 140. In addition, a plurality of electrode cells may be laminated to form an electrode assembly 150. For example, the electrode assembly 150 may be formed by winding, lamination, z-folding, etc. the separation membrane 140.

The electrode assembly may be housed in a case 160 together with the electrolyte to form a lithium secondary battery.

The electrolyte may include, for example, a lithium salt, and the lithium salt may be housed in the case in a non-aqueous electrolyte state together with an organic solvent.

The lithium salt may be represented by, for example, Li⁺X⁻. An anion (X−) of the lithium salt may be, for example, any one selected from F⁻, Cl⁻, Br⁻, I⁻, NO₃⁻, N(CN)₂⁻BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. In some embodiments, the lithium salt may include at least one of LiBF₄ and LiPF₆.

The organic solvent may include, for example, any one or more selected from ethylene carbonate (EC), propylene carbonate (PC), dimethyl carbonate (DMC), diethyl carbonate (DEC), ethylmethyl carbonate (EMC), methylpropyl carbonate, dipropyl carbonate, dimethyl sulfoxide, acetonitrile, dimethoxyethane, diethoxyethane, vinylene carbonate, sulforane, γ-butyrolactone, propylene sulfite, tetrahydrofurane and the like.

The lithium secondary battery may be manufactured, for example, in a cylindrical shape, a square shape, a pouch shape or a coin shape.

Hereinafter, preferred examples and comparative examples of the present invention will be described. However, the following examples are only preferred examples of the present invention, and the present invention is not limited thereto.

### Example 1

(1) Preparation of Lithium Metal Oxide

To prepare the lithium metal oxide, an aqueous metal precursor solution, in which NiSO₄, CoSO₄ and MnSO₄ were mixed in a molar ratio of 83:11:6, was prepared.

Distilled water was input into a co-precipitation reactor, and internal dissolved oxygen was removed by bubbling with nitrogen gas while maintaining an internal temperature at 63° C.

The aqueous metal precursor solution, an aqueous ammonia solution, and an aqueous NaOH solution as a pH adjuster were input into the co-precipitation reactor, and a co-precipitation reaction was performed while stirring at 500 rpm.

At this time, the aqueous metal precursor solution and the aqueous ammonia solution were input at 0.3 L/h and 0.03 L/h, respectively, thereby controlling so that the aqueous metal precursor solution and the aqueous ammonia solution had a residence time of 5 to 8 hours in the co-precipitation reactor. In addition, the pH of the co-precipitation reactant was maintained at 10.5 to 11.

After the end of the co-precipitation reaction, the precipitate was filtered and dried at 120° C. for 12 hours to obtain a metal hydroxide (Ni_{0.83}Co_{0.12}Mn_{0.05}(OH)₂).

1 kg of the metal hydroxide and lithium hydroxide (LiOH.H₂O) were input into a high-speed mixer in a Li/M molar ratio of 1.03, and then mixed.

The prepared mixture was input into a calcination furnace (Noritake, RHK Simulator), then the mixture was calcined at a temperature of 740 to 760° C. (heating rate of 3° C./min) for 16 hours. At this time, oxygen was continuously passed through at a flow rate of 5 L/min.

After the end of the calcination, the calcined product was naturally cooled to room temperature, followed by grinding and classification to obtain lithium metal oxide LiNi_{0.83}Co_{0.12}Mn_{0.05}O₂.

(2) Preparation of Lithium Secondary Battery

A cathode slurry was prepared by mixing the lithium metal oxide as a cathode active material, carbon black as a conductive material, and polyvinylidene fluoride (PVDF) as a binder in a weight ratio of 92:5:3.

The cathode slurry was uniformly applied to a region of an aluminum foil (thickness: 15 μm) having a protrusion part (cathode tab) on one side except for the protrusion part, followed by drying and rolling to prepare a cathode.

An anode slurry was prepared by mixing a mixture of artificial graphite and natural graphite (weight ratio of 7:3) as an anode active material, styrene-butadiene rubber as a binder, and carboxymethyl cellulose as a thickener in a weight ratio of 97:1:2.

The anode slurry was uniformly applied to a region of an aluminum foil (thickness: 15 μm) having a protrusion part (anode tab) on one side except for the protrusion part, followed by drying and rolling to prepare an anode.

An electrode assembly was formed by interposing a polyethylene separation membrane (thickness: 20 μm) between the cathode and the anode. Next, a cathode lead and an anode lead were welded and connected to the cathode tab and the anode tab, respectively.

The electrode assembly was housed in a pouch (case) so that some regions of the cathode lead and the anode lead were exposed to an outside of the pouch, followed by sealing three sides of the pouch except for a side of an electrolyte injection part.

After injecting the electrolyte and sealing the side of the electrolyte injection part, a lithium secondary battery was prepared by impregnation for 12 hours.

The electrolyte used herein was prepared by dissolving 1M LiPF₆ solution (a mixed solvent of EC/EMC/DEC in a volume ratio of 25:30:45), and adding and mixing 1% by weight (‘wt. %’) of fluoroethylene carbonate (FEC), 0.3 wt. % of vinylethylene carbonate (VC), 1.0 wt. % of lithium difluorophosphate (LiPO₂F₂), 0.5 wt. % of 1,3-propane sultone (PS), and 0.5 wt. % of prop-1-ene-1,3-sultone (PRS) based on the total weight of the electrolyte.

### Example 2

A lithium secondary battery was prepared by performing the same procedures as described in Example 1, except that the calcination time was changed to 10 hours when preparing the lithium metal oxide.

### Example 3

A lithium secondary battery was prepared by performing the same procedures as described in Example 1, except that calcination was performed at a temperature of 720° C. or higher and less than 740° C. when preparing the lithium metal oxide.

### Example 4

A lithium secondary battery was prepared by performing the same procedures as described in Example 1, except that the aqueous metal precursor solution and the aqueous ammonia solution were controlled to have a residence time of 2 to 4 hours in the co-precipitation reactor when preparing the metal hydroxide.

### Comparative Example 1

When preparing the metal hydroxide, the aqueous metal precursor solution and the aqueous ammonia solution were changed to have a residence time of 2 to 4 hours in the co-precipitation reactor. In addition, when preparing the lithium metal oxide, calcination was performed at a temperature of 720° C. or higher and less than 740° C. for 10 hours.

A lithium secondary battery was prepared by performing the same procedures as described in Example 1, except for the above-described changes.

### Comparative Example 2

A lithium secondary battery was prepared by performing the same procedures as described in Example 1, except that calcination was performed for 10 hours at a temperature of 720° C. or higher and less than 740° C. when preparing the lithium metal oxide.

### Comparative Example 3

When preparing the metal hydroxide, the aqueous metal precursor solution and the aqueous ammonia solution were changed to have a residence time of 2 to 4 hours in the co-precipitation reactor. In addition, when preparing the lithium metal oxide, calcination was performed in a temperature range of 720° C. or higher and less than 740° C.

A lithium secondary battery was prepared by performing the same procedures as described in Example 1, except for the above-described changes.

### Comparative Example 4

When preparing the metal hydroxide, the aqueous metal precursor solution and the aqueous ammonia solution were changed to have a residence time of 2 to 4 hours in the co-precipitation reactor. In addition, when preparing lithium metal oxide, the calcination time was changed to 10 hours.

A lithium secondary battery was prepared by performing the same procedures as described in Example 1, except for the above-described changes.

### Experimental Example 1: Evaluation of Particle Size Distribution Change Rate and Specific Surface Area Change Rate

(1) Measurement of Particle Sizes (D₁₀, D₅₀ and D₉₀) Before and after the Pressurization Treatment

The particle sizes were measured by a laser diffraction method using a laser diffraction particle size measuring device (Microtrac, MT 3000).

Herein, D₁₀ means a particle size at a point of 10% of the volume particle size distribution, D₅₀ means a particle size at a point of 50% of the volume particle size distribution, and D₉₀ means a particle size at a point of 90% of the volume particle size distribution.

The particle sizes of the lithium metal oxides of the examples and comparative examples were measured without the pressurization treatment.

Next, the lithium metal oxides of the examples and comparative examples were subjected to pressurization treatment at 4.5 t/cm² for 1 minute, and then the particle sizes were measured.

The pressurization treatment was performed by inputting lithium metal oxides of the examples and comparative examples into a circular holder having a diameter of 13 mm, and pressing the same with a hydraulic press (Carver, No. 4350).

D₁₀, D₅₀, and D₉₀ before and after the pressurization treatment of the lithium metal oxide are shown in Table 1 below.

A (D₉₀−D₁₀)/D₅₀ value in the case of without pressure-treating was defined as X, and a (D₉₀−D₁₀)/D₅₀ value in the case of pressure-treating at 4.5 t/cm² was defined as X_{4.5t}, then values were calculated, and results thereof are described in Table 1 below.

As a separate additional experimental example, the lithium metal oxides of Example 1 and Comparative Example 1 were subjected to pressurization treatment at 1 t/cm² for 1 minute, and D₅₀ was measured, respectively. A change rate of the particle size (D₅₀) (‘D₅₀ change rate’) (%) before and after the pressurization treatment was calculated by (D₅₀ before the pressurization treatment−D₅₀ after the pressurization treatment)/D₅₀ before the pressurization treatment×100. The D₅₀ change rate of the lithium metal oxides of Example 1 was 2.1%, and the D₅₀ change rate of the lithium metal oxide of Comparative Example 1 was 7.8%.

(2) Evaluation of Particle Size Distribution Change Rate (ΔX)

A particle size distribution change rate (ΔX) value was calculated according to Equation 1 below using the X values and the X_{4.5t} values measured in the above (1), and results thereof are described in Table 2 below.

ΔX(%)=(X_{4.5t}−X)/X×100 [Equation 1]

(3) Evaluation of Specific Surface Area Change Rate (ΔY)

Specific surface areas (BET values) of the lithium metal oxides of the examples and comparative examples were measured using a BET measuring instrument (Micrometrics, ASAP2420).

The BET values were measured without pressure-treating the lithium metal oxides of the examples and comparative examples. Next, the lithium metal oxides of the examples and comparative examples were subjected to pressurization treatment at 4.5 t/cm² for 1 minute, and then BET values were measured.

A BET value in the case of without pressure-treating was defined as Y, and a BET value in the case of pressure-treating was defined as Y_{4.5t}.

Specific surface area change rates (ΔY) value were calculated according to Equation 2 below using the measured Y values and Y_{4.5t} values, and results thereof are described in Table 2 below.

ΔY(%)=(Y_{4.5t}−Y)/Y×100 [Equation 2]

### Experimental Example 2: Evaluation of High Temperature Life-Span Characteristics and Storage Performance

(1) Measurement of Initial Charge Capacity and Initial Discharge Capacity

The lithium secondary batteries of the examples and comparative examples were CC/CV charged (1 C 4.25 V 0.1 C CUT-OFF) at room temperature, and CC-discharged (1 C 3.0 V CUT-OFF) to measure initial charge capacity and initial discharge capacity.

(2) Evaluation of High Temperature Life-Span Characteristics (Capacity Retention Rate at 45° C.)

The lithium secondary batteries of the examples and comparative examples were CC/CV charged (1 C 4.25 V 0.1 C CUT-OFF), and CC-discharged (1 C 3.0 V CUT-OFF) at 45° C.

The charge and discharge were repeatedly performed 200 times.

The high temperature capacity retention rate was calculated by a percentage of value obtained by dividing the discharge capacity measured at the 200th time by the initial discharge capacity measured in the above (1).

High temperature capacity retention rate (%)=(200th discharge capacity/Initial discharge capacity)×100

The calculated high temperature capacity retention rates are described in Table 2 below.

(3) Evaluation of High Temperature Storage Performance (Gas Generation Amount at 60° C.)

The lithium secondary batteries of the examples and comparative examples were charged to 100% state-of-charge (SOC) (4.25 V 0.05 C CUT-OFF), and stored in a chamber at 60° C.

After 4 weeks, amounts of gas generated inside the lithium secondary batteries were analyzed using gas chromatography, and the analyzed values are described in Table 2 below.

TABLE 1

| | Before pressurization | | | | After pressurization | | | |
|---|---|---|---|---|---|---|---|---|
| | treatment | | | | Treatment (4.5 t/cm²) | | | |
| | D₁₀ | D₅₀ | D₉₀ | X | D₁₀ | D₅₀ | D₉₀ | X_{4.5t} |
| Example 1 | 5.92 | 13.10 | 21.19 | 1.166 | 3.13 | 11.39 | 19.10 | 1.402 |
| Example 2 | 3.54 | 9.48 | 16.29 | 1.345 | 2.29 | 7.42 | 15.61 | 1.795 |
| Example 3 | 3.17 | 9.27 | 21.63 | 1.991 | 2.61 | 5.30 | 18.24 | 2.949 |
| Example 4 | 5.91 | 12.72 | 19.92 | 1.101 | 2.12 | 9.21 | 17.99 | 1.723 |
| Comparative | 5.58 | 10.96 | 18.53 | 1.182 | 0.65 | 7.35 | 16.20 | 2.116 |
| Example 1 | | | | | | | | |
| Comparative | 4.43 | 10.99 | 22.30 | 1.626 | 1.85 | 7.13 | 18.71 | 2.365 |
| Example 2 | | | | | | | | |
| Comparative | 4.80 | 11.28 | 20.96 | 1.433 | 1.33 | 8.12 | 19.91 | 2.288 |
| Example 3 | | | | | | | | |
| Comparative | 6.40 | 12.48 | 20.41 | 1.123 | 2.45 | 8.73 | 19.01 | 1.897 |
| Example 4 | | | | | | | | |

TABLE 2

| | | | Capacity retention | Gas generation |
|---|---|---|---|---|
| | ΔX | ΔY | rate at 45° C. | amount at 60° C. |
| | (%) | (%) | (%) | (ml) |
| Example 1 | 20.3 | 12.1 | 95 | 5.7 |
| Example 2 | 33.5 | 29.7 | 95 | 5.3 |
| Example 3 | 48.1 | 43.0 | 94 | 8.3 |
| Example 4 | 56.4 | 34.7 | 93 | 9.4 |
| Comparative | 79.1 | 82.4 | 76 | 34.2 |
| Example 1 | | | | |
| Comparative | 45.4 | 69.2 | 77 | 32.9 |
| Example 2 | | | | |
| Comparative | 59.7 | 55.2 | 84 | 24.5 |
| Example 3 | | | | |
| Comparative | 69.0 | 38.9 | 80 | 26.6 |
| Example 4 | | | | |

Referring to Table 2 above, the lithium secondary batteries of the examples, in which the particle size distribution change rate (ΔX) value was 60% or less and the specific surface area change rate (ΔY) value was 50% or less, exhibited the improved high temperature life-span characteristics and high temperature storage performance.

For example, the lithium secondary batteries of the examples exhibited about 20% improvement in the capacity retention rate at 45° C. compared to the lithium secondary batteries of the comparative examples.

In addition, the lithium secondary batteries of the examples exhibited gas generation amount values reduced by at most about ⅙ compared to the lithium secondary batteries of the comparative examples.

The lithium secondary battery of Comparative Example 1, in which the particle size distribution change rate (ΔX) value exceeded 60% and the specific surface area change rate (ΔY) value exceeded 50%, the high temperature life-span characteristics and high temperature storage performance were inferior compared to the lithium secondary batteries of the examples.

The lithium secondary batteries of Comparative Examples 2 to 4, in which the particle size distribution change rate (ΔX) value exceeded 60% or the specific surface area change rate (ΔY) value exceeded 50%, the high temperature life-span characteristics and high temperature storage performance were inferior compared to the lithium secondary batteries of the examples.

The secondary batteries of Examples 1 and 2, in which the particle size distribution change rate (ΔX) value was 40% or less and the specific surface area change rate (ΔY) value was 30% or less, exhibited more improved high temperature life-span characteristics and high temperature storage performance.

### DESCRIPTION OF REFERENCE NUMERALS

100: Cathode
105: Cathode current collector
110: Cathode active material layer
120: Anode active material layer
125: Anode current collector
130: Anode
140: Separation membrane
160: Case

What is claimed is:

1. A cathode active material for a lithium secondary battery comprising:
a lithium metal oxide containing 80 mol % or more of nickel among all elements except for lithium and oxygen,
wherein the cathode active material has a particle size distribution change rate (ΔX) of 60% or less represented by Equation 1 below, and
wherein a specific surface area change rate (ΔY) of 50% or less represented by Equation 2 below:
ΔX(%)=(X_{4.5t}−X)/X×100 [Equation 1]
ΔY(%)=(Y_{4.5t}−Y)/Y×100 [Equation 2]
wherein, in Equation 1, X is a (D₉₀−D₁₀)/D₅₀ value of the cathode active material measured without pressure-treating the cathode active material, and X_{4.5t} is a (D₉₀−D₁₀)/D₅₀ value of the cathode active material measured after pressure-treating the cathode active material at 4.5 t/cm² for 1 minute, and
wherein, in Equation 2, Y is a BET value of the cathode active material measured without pressure-treating the cathode active material, and Y_{4.5t} is a BET value of the cathode active material measured after pressure-treating the cathode active material at 4.5 t/cm² for 1 minute.

2. The cathode active material for a lithium secondary battery according to claim 1, wherein X is 1 to 2.

3. The cathode active material for a lithium secondary battery according to claim 1, wherein X_{4.5t} is greater than 1 and 3 or less.

4. The cathode active material for a lithium secondary battery according to claim 1, wherein the particle size distribution change rate (ΔX) is 40% or less, and the specific surface area change rate (ΔY) is 30% or less.

5. The cathode active material for a lithium secondary battery according to claim 1, wherein the particle size D₁₀, D₅₀ and D₉₀ of the cathode active material measured without the pressure-treating the cathode active material, respectively, 3 to 6 μm, 8 to 15 μm and 15 to 22 μm.

6. The cathode active material for a lithium secondary battery according to claim 1, wherein the particle size D₁₀, D₅₀ and D₉₀ of the cathode active material measured after the pressure-treating the cathode active material at 4.5 t/cm² for 1 minute, respectively, 2 to 4 μm, 5 to 14 μm and 14 to 20 μm.

7. The cathode active material for a lithium secondary battery according to claim 1, wherein a change rate (ΔD₅₀) of the particle size D₅₀ of the cathode active material before and after the pressurization treatment at 4.5 t/cm² for 1 minute represented by Equation 3 below is 50% or less:
ΔD₅₀(D₅₀)=(D₅₀ measured without the pressurization treatment−D₅₀ measured after the pressurization treatment)/D₅₀ measured without the pressurization treatment×100. [Equation 3]

8. The cathode active material for a lithium secondary battery according to claim 1, wherein the lithium metal oxide is represented by Formula 1 below:
LiₓNiₐCo_{b}M_{c}O_{y} [Formula 1]
Wherein, in Formula 1, M is at least one of Al, Zr, Ti, B, Mg, Mn, Ba, Si, Y, W and Sr, and x, y, a, b and c are in a range of 0.9≤x≤1.2, 1.9≤y≤2.1, 0.8≤a≤1, 0≤c/(a+b)≤0.13 and 0≤c≤0.11, respectively.

9. A lithium secondary battery comprising:
a cathode which comprises the cathode active material according to claim 1; and
an anode disposed to face the cathode.
